(19) United States
(12) Patent Application Publication
(10) Pub. No.: US 2006/0054157 A1
(43) Pub. Date: Mar. 16, 2006

(54) Smokeless grill

(76) Inventors: Xi-Zhi Wang, Guangzhou City (CN); Yao-Qu Liang, Shunde City (CN)

Correspondence Address: Raymond Y. Chan, 108 N. Ynez Ave., #128, Monterey Park, CA, 91754, US

(21) Appl. No.: 11/150,018

(22) Filed: Jun. 10, 2005

(30) Foreign Application Priority Data
Sep. 15, 2004 (CN) 200420088329.X

(51) Int. Cl. F24B 3/00; A47J 37/00

(52) U.S. Cl. 126/25 R

(57) ABSTRACT

The present invention discloses a new type of practical, smokeless barbecue grill which relates to the field of household food processing appliances, particularly relates to the electric-heat grill used for roasting food. This electric-heated smokeless barbecue grill comprises an electric heat tube, a metal heat-reflection cover, a honeycomb grid, a stand, a grill rack, and a base tray. All those parts of the grill are set up in the pattern of: the base tray is on the stand, above the base tray there is the grill rack, above the rack is the honey comb grid, above the grid there is the electric-heat tube, above which is the metal heat-reflection cover having an arc shape, the rack is under the electric heat tube. This new and practical grill can be used for effectively preventing oil smoke which is resulted from the splashing down of oil drop from the meat, and avoiding a lot of oil smoke during the barbecue process. In addition to the ease of use, this smokeless barbecue grill is suitable for indoor using as a household appliance.

### BACKGROUND OF THE PRESENT INVENTION

1. Field of Invention

The present invention is new and practical smokeless grill which relates to the field of household food processing appliances, particularly to the electric heat grill used for cooking barbeque (BBQ) food.

2. Description of Related Arts

Most conventional BBQ grills produce a lot of smoke produced by its fire flame during the process of preparing BBQ food, thus are not suitable for household or indoor use. Regular electric heat BBQ grills cause the same problem for users, since grease, fat or oil drop produced from the heated meat will splash down on the electric heat plate in such electric heat grill.

Such problem also limits the household and indoor using of BBQ ovens. The oil smoke produced while preparing BBQ food processes has troubled users of BBQ grill for a long time.

In order to avoid or reduced the oil smoke produced by food heating devices when oil or grease are drips down from the meat being cooked down onto the meat heating device during the preparation of BBQ food, the dripping of oil or grease from the meat has to be avoided

### SUMMARY OF THE PRESENT INVENTION

A main object of the present is to provide a smokeless grill comprises an electric heat tube, a metal heat-reflection cover, a stand, a grill rack, and a base tray, wherein the stand is set up on the base tray, the grill rack is provided on top of the base tray, the honeycomb grid is set above the grill rack, the heat tube is provided above the honeycomb grid, the electric heat tube is provided above the arc shape metal heat reflection cover.

Another object of the present invention is to provide a smokeless grill which can be used for effectively avoiding oil smoke production when oil or grease drips from meat from splashing around, such that the grill is suitable for household and indoor use.

Accordingly, in order to accomplish the above objects, the present invention provides smokeless grill for grilling a food in a smokeless manner, comprising:

a heat tube;

a metal heat-reflection cover;

a honeycomb grid,

a stand;

a grill rack set above the base tray; and

a base tray, wherein the base tray is provided above the stand, the grill rack is provided above the base tray, the honeycomb is provided above the grill rack, the electric heat tube is provided above the honeycomb grid, the heat-reflection cover, such that the grill rack is underneath the heat tube, the honeycomb grid is provided between the grill rack and the electric heat tube, and the base tray is provided under the grill rack.

These and other objectives, features, and advantages of the present invention will become apparent from the following detailed description, the accompanying drawings, and the appended claims.

### BRIEF DESCRIPTION OF THE DRAWINGS

FIG. 1 is a side view of the smokeless grill according to the preferred embodiment of the present invention.

FIG. 2 is a front view of the present invention according to the above preferred embodiment of the present invention.

FIG. 3 is another side view of the present invention according to the above preferred embodiment of the present invention.

### DETAILED DESCRIPTION OF THE PREFERRED EMBODIMENT

The purpose of the present invention is achieved by designing the new and practical BBQ grill which comprise an electric heat tube, a metal heat-reflection cover, a stand, a grill rack, and a base tray, wherein the stand is set up on the base tray, the grill rack is provided on top of the base tray, the honeycomb grid is set above the grill rack, the heat tube is provided above the honeycomb grid, the electric heat tube is provided above the arc shape metal heat reflection cover.

Since the grill rack is provided under the electric heat tube, the heat emitted from the electric heat tube will be reflected and concentrated on the grill rack by the heat-reflection cover.

Due to the fact that the electric heat tube is set up above the grill rack, the heat is emitted from top to bottom, such that the oil drops from the meat can be avoided from splashing onto the electric heat tube.

Because of the honeycomb grid is provided between the rack and the electric heat tube, the production of oil smoke from dripping of oil from food onto the heat tube is effectively avoided. The base tray, which is beneath the grill rack, is provided for holding the oil or grease dripping down from the meat.

When the smokeless grill is connected to a power source, the electric heat tube begins to emit heat downwardly to the food. At the same time, the heat from the electric tube will be reflected onto the grill rack by the heat-reflection cover.

As the food is laid on the grill rack, the oil or grease produced from the food will drip onto the base tray which is directly under the grill rack. As a result, the oil drips from the meat will be kept away from the heat tube by the honeycomb grid.

The water in the base tray which is underneath the grill rack will cool of the oil which drips from the food, and avoiding the production of oil smoke.

The stand of the present invention can be that of a ground model and a bench model. When used as the ground model, the legs of the stand will be directly put onto the ground to support the grill rack and the base tray, with the base tray provided at the middle position.

When used as the bench model, the stand of the present oven can be put on top of the table or bench to support the grill rack and the base tray, and with the base tray set up at its lower position.

The present new and practical invention can be easily used for avoiding a large amount of oil smoke which may result form the dripping or splashing down of oil or grease from the meat during the preparation of the BBQ food. As a result, the smokeless grill oven is suitable for household and indoor use.

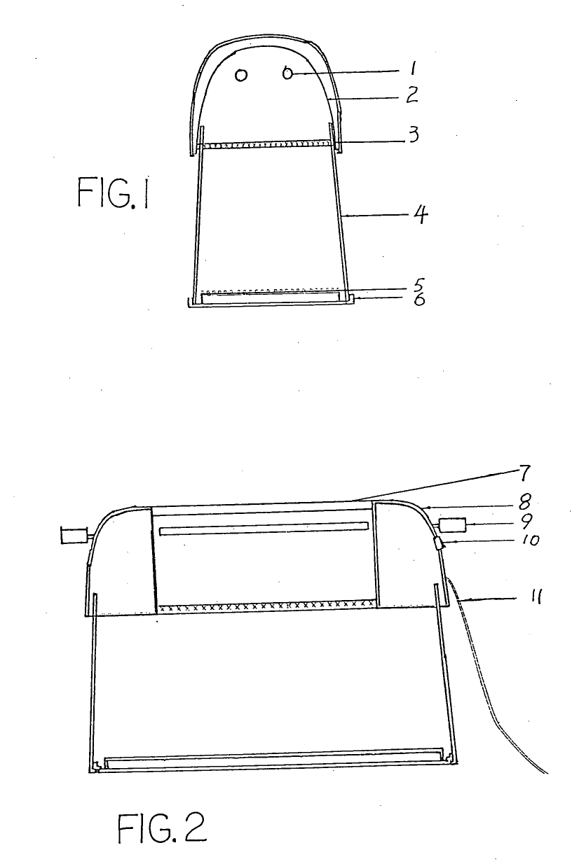

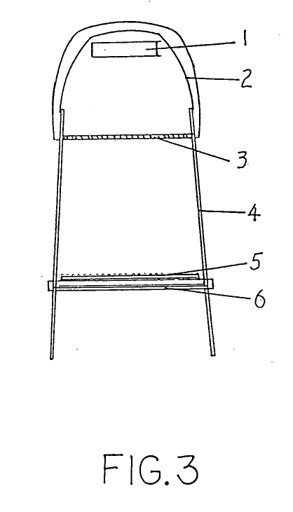

According to FIG. 1 and 2 of the drawings, the structure of the present invention is illustrated, wherein the smokeless grill comprises an electric heat tube 1, a metal heat-reflection cover 2, a honeycomb grid 3, a stand 4, a grill rack 5, a base tray 6, an outer cover 7, a side cover 8, a handle 9, a switch 10, a power cord 11.

The base tray 6 is set at a lower position than the stand 4, wherein some water is filled into the base tray 6. The grill rack 5 is provided above the base tray 6. The honeycomb grid 3 is provided above the grill rack 5. The electric heat tube 1 is provided above the honeycomb grid 3. The arc shape metal heat-reflection cover 2 is provided above the electric heat tube 1, wherein the heat-reflection cover 2 can focus and reflect the heat emitted from the electric heat tube 1 onto the grill rack 5.

Between the grill rack 5 and the electric heat tube 1 provided the honeycomb grid 3, which can prevent oil or grease dripping onto the electric heat tube 1, thus avoid the production of oil smoke. The side cover 8 is provided on the side of the electric heat tube 1. The outer cover 7 is provided outside the electric heat tube 1.

The switch 10 and handle 9 are provided on the side cover 8. The power cord is connected with the electric heat tube 1. When the switch 10 is turned on, the heat emitted from the electric heat tube reaches to cook the food.

The heat-reflection cover 2 above the electric heat tube 1 will reflect the heat onto the grill rack 5. The food will be put on top of the grill rack 5. The oil and grease from the food will then drip onto the base tray 6, which is directly underneath the grill rack 5. As a result, the oil and grease from the meat will be separated by the honeycomb grid 3.

Referring to FIG. 3 of the drawings, the structure of the present invention is shown, wherein the smokeless grill comprises the heat tube 1, the heat-reflection cover 2, the honeycomb grid 3, the stand 4, the grill rack 5, and the base tray 6. The stand 4 is that of a ground model, where the legs of the stand are placed on the ground.

The base tray 6 is provided at a middle section of the stand. The base tray 6 is provided for being filled by water prior to the grilling of food. The grill rack 5 is provided above the base tray 6, wherein the honeycomb grid 3 is provided above the grill rack 5. The electric heat tube 1 is provided above the grid 3.

The arc shape metal heat-reflection cover 2 is placed above the electric heat tube 1, such that the heat emitted from the electric heat tube 1 is focused and reflected on to the grill rack 5.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A smokeless grill for grilling a food in a smokeless manner, comprising:
a heat tube;
a metal heat-reflection cover;
a honeycomb grid,
a stand;
a grill rack set above said base tray; and
a base tray, wherein said base tray is provided above said stand, said grill rack is provided above said base tray, said honeycomb is provided above said grill rack, said electric heat tube is provided above said honeycomb grid, said heat-reflection cover, such that said grill rack is underneath said heat tube, said honeycomb grid is provided between said grill rack and said electric heat tube, and said base tray is provided under said grill rack.

2. The smokeless grill, as recited in claim 1, wherein said base tray is provided for being filled with water before said food is grilled.

3. The smokeless grill, as recited in claim 1, wherein said base tray is provided at a middle section of said stand, wherein said stand provides support said grill rack and said base tray.

4. The smokeless grill, as recited in claim 1, wherein said base tray is provided at the bottom position of said stand.
